(19) United States
(12) Patent Application Publication
(10) Pub. No.: US 2025/0227198 A1
(43) Pub. Date: Jul. 10, 2025

(54) SYSTEM AND METHOD FOR IMAGE TEMPORAL INTERPOLATION FOR DYNAMIC IMAGING

(71) Applicant: Beth Israel Deaconess Medical Center, Inc., Boston, MA (US)

(72) Inventors: Manuel A. Morales, Charlestown, MA (US); Reza Nezafat, Newton, MA (US)

(21) Appl. No.: 18/409,385

(22) Filed: Jan. 10, 2024

(51) Int. Cl. H04N 7/01

(52) U.S. Cl. CPC H04N 7/0135

(57) ABSTRACT

A system for increasing a frame rate of a dynamic image includes an input for receiving a set of consecutive image frames of a first dynamic image having a first plurality of image frames and a first frame rate. The system further includes a deformation encoding neural network coupled to the input and configured to derive at least one parameter characterizing dynamics of the set of consecutive image frames and to generate an interpolated image frame based on the at least one parameter, and a post-processing module coupled to the deformation encoding neural network and configured to receive one or more interpolated image frames from the deformation encoding neural network, to create a second plurality of image frames comprising the one or more interpolated image frames and the first plurality of image frames, and to generate a second dynamic image using the second plurality of image frames, the second dynamic image having a second frame rate higher than the first frame rate.

### STATEMENT REGARDING FEDERALLY SPONSORED RESEARCH

This invention was made with government support under Grant No. HL158077 awarded by the National Institutes of Health. The government has certain rights in the invention.

### FIELD

The present disclosure relates generally to dynamic imaging and, more particularly, to systems and methods for increasing the frame rate of a dynamic image using a deformation encoding neural network and for training a deformation encoding neural network for interpolating an image frame.

### BACKGROUND

Various imaging modalities such as, for example, magnetic resonance imaging (MRI), ultrasound. positron emission tomography (PET), and echocardiography, may be used for dynamic imaging which can be used to provide temporal information such as, for example, temporal changes. Insufficient temporal resolution can impact the clinical utility of dynamic imaging applications.

In an example, cardiac MRI is a non-invasive, non-ionizing imaging modality used in the diagnosis, risk stratification, and monitoring of patients with cardiovascular disease. One of the integral parts of a cardiac MRI exam is cine imaging, which uses electrocardiogram (ECG)-segmented or real-time imaging. However, there is a tradeoff between temporal resolution, spatial resolution, signal-to-noise ratio, and scan time. In ECG-segmented cine, increased temporal resolution is achieved by having longer breath-holds due to increased scan time. In real-time imaging, higher frame rates are reached at the expense of lower spatial resolution. Achieving high spatial and temporal resolution requires image acceleration, which compromises image quality and signal-to-noise ratio. Yet insufficient temporal resolution impacts the clinical utility of cine for assessing diastolic function, exercise wall-motion abnormality, valvular function, or in interventional applications.

It would be desirable to provide a system and method for improving the temporal resolution of dynamic imaging for various applications.

### SUMMARY

In accordance with an embodiment, a system for increasing a frame rate of a dynamic image includes an input for receiving a set of consecutive image frames of a first dynamic image. The first dynamic image has a first plurality of image frames and a first frame rate. The system further includes a deformation encoding neural network coupled to the input and configured to derive at least one parameter characterizing dynamics of the set of consecutive image frames and to generate an interpolated image frame based on the at least one parameter, and a post-processing module coupled to the deformation encoding neural network and configured to receive one or more interpolated image frames from the deformation encoding neural network, to create a second plurality of image frames comprising the one or more interpolated image frames and the first plurality of image frames, and to generate a second dynamic image using the second plurality of image frames, the second dynamic image having a second frame rate higher than the first frame rate.

In accordance with another embodiment, a method for increasing a frame rate of a dynamic image includes receiving a first dynamic image having a first plurality of image frames and a first frame rate and selecting a plurality of sets of consecutive image frames from the first plurality of image fames of the first dynamic image. For each set of consecutive image frames the method includes providing the set of consecutive image frames to a deformation encoding neural network, generating an interpolated image frame using the deformation encoding neural network by deriving at least one parameter characterizing dynamics of the set of consecutive image frames and generating the interpolated image frame based on the at least one parameter, and storing the interpolated image frame in data storage. The method further includes creating a second plurality of image frames comprising the first plurality of image frames and the interpolated image frame generated from each set of consecutive image frames, and generating a second dynamic image using the second plurality of image frames, the second dynamic image having a second frame rate higher than the first frame rate.

In accordance with another embodiment, a method for training a deformation encoding neural network for interpolating an image frame includes receiving a plurality of dynamic images, wherein each dynamic image has a plurality of image frames and generating a training sample from each dynamic image. Generating a training sample from each dynamic image includes selecting an image frame from the plurality of image frames of the dynamic image for a ground truth image frame, selecting a set of adjacent image frames relative to the ground truth image frame and with a longer temporal spacing than a temporal spacing of the plurality of image frames in the dynamic image, and storing the training sample including the ground truth image frame and the set of adjacent image frames relative to the ground truth image frame. The method further includes training the deformation encoding neural network for interpolating an image frame using each generated training sample and a loss function, and storing the trained deformation encoding neural network for interpolating an image frame in data storage.

### BRIEF DESCRIPTION OF THE DRAWINGS

The present disclosure will hereafter be described with reference to the accompanying drawings, wherein like reference numerals denote like elements.

FIG. 1 is a block diagram of a system for increasing a frame rate of a dynamic image in accordance with an embodiment;

FIG. 2 illustrates a method for increasing a frame rate of a dynamic image in accordance with an embodiment;

FIG. 3 is a block diagram illustrating a process for training a deformation encoding neural network for interpolating image frames for a dynamic image in accordance with an embodiment;

FIG. 4A illustrates a method for training a deformation encoding neural network for interpolating image frames for a dynamic image in accordance with an embodiment;

FIG. 4B illustrates a method for generating training samples for a training dataset in accordance with an embodiment;

FIG. 5 is a block diagram illustrating a process for generating training samples for a training dataset in accordance with an embodiment;

FIGS. 6A-6D illustrate an example model architecture for a deformation encoding neural network for interpolating image frames for a dynamic image in accordance with an embodiment;

FIG. 7 is a block diagram of an example computer system in accordance with an embodiment; and

FIG. 8 is a block diagram of an example MRI system in accordance with an embodiment.

### DETAILED DESCRIPTION

The present disclosure describes systems and methods for increasing the frame rate of a dynamic image using a deformation encoding neural network and describes systems and methods for training a deformation encoding neural network for interpolating an image frame. Advantageously, the disclosed systems and methods to increase the frame rate of a dynamic image are configured to increase the frame rate after the images are reconstructed. Therefore, no modification to the existing imaging protocols used to acquire and reconstruct the dynamic image are necessary. Advantageously, the disclosed system and method for increasing the frame rate of a dynamic image does not require any specific image acquisition technique and may readily be integrated into a clinical workflow. In addition, the frame rate may be increased without changes to other characteristics of the dynamic image, for example, the spatial resolution, signal-to-noise ratio (SNR), or scan time. The system for increasing the frame rate of a dynamic image can be used with dynamic images acquired with various imaging modalities, for example, magnetic resonance imaging (e.g., dynamic MRI such as cine imaging, phase contrast imaging, dynamic contrast enhanced imaging, perfusion imaging, etc.), ultrasound, positron emission tomography (PET), echo cardiography, etc. and for various applications such as, for example, cardiac imaging, neural imaging, abdominal imaging, etc. The disclosed system and method can be used inline with an image reconstruction pipeline or offline as a post-processing tool.

The disclosed system for increasing the frame rate of a dynamic image can include a deformation encoding neural network. The dynamic image of the subject can have a plurality of image frames and a frame rate. In some embodiments, a set of consecutive image frames (e.g., an even number of image frames such as 2, 4, 6, etc.) from a dynamic image of a subject may be provided as input to the deformation encoding neural network. The deformation encoding neural network can be a trained neural network configured to derive one or more parameters characterizing dynamics of the set of consecutive image frames and to generate an interpolated image frame based on the one or more derived parameters. In some embodiments, the one or more parameters can include, for example, motion, deformation, etc. For example, for cardiac cine imaging, the parameters can include motion and deformation of the heart and for phase contrast MR imaging, the parameters can include contrast changes. The deformation encoding neural network can be configured to use the derived parameters to interpolate a new image frame between the existing image frames in the set of consecutive image frames. Accordingly, the information determined by the deformation encoding neural network regarding how the one or more parameters changes over time can be used to interpolate a new in-between image frame. In some embodiments, the deformation encoding neural network may be used to generate a plurality of interpolated image frames one at a time using different sets of consecutive image frames from the dynamic image of the subject as input. In some embodiments, a sliding window technique may be used to select each set of consecutive image frames used to generate the different interpolated image frames. For example, if the dynamic image of the subject includes 100 image frames and each set of consecutive image frames includes four image frames, a first set of consecutive image frames may include image frames 1-4. To select a second set of consecutive image frames, the “sliding window” can be moved or shifted by one image frame and the second set of consecutive images frames can include image frames 2-5. In this example, a third set of consecutive image frames can includes image frames 3-6. While various embodiments and examples are described herein with respect a set of consecutive image frames including four image frames, it should be understood that other even numbers of image frames may be used e.g., 2, 6, 8, etc.).

In some embodiments, the one or more interpolated image frames generated by the deformation encoding neural network can be provided to a post-processing module which can be configured to generate a dynamic image with an increased frame rate. For example, in some embodiments, the post processing module can be configured to create a second plurality of image frames that includes the interpolated image frame(s) generated by the deformation encoding neural network and the original plurality of image frames of the dynamic image of the subject. The post processing module can then generate a dynamic image with an increased frame rate using the second plurality of image frames. Accordingly, by applying the deformation encoding neural network to an existing dynamic image of a subject collected through conventional protocols, the framerate of the existing dynamic image can be increased. In some embodiments, the deformation encoding neural network can be applied to the second plurality of image frames (i.e., the dynamic image with increased frame rate) to generate a further increase in frame rate. In some embodiments, the dynamic image with an increased frame rate can be displayed to a user or operator. In addition, the parameters derived by the deformation encoding neural network may also be stored and used for further analysis and evaluation, for example, for a cardiac cine dynamic image, the deformation encoding neural network may derive and provide cardiac motion vector fields which can be utilized to assess cardiac deformation.

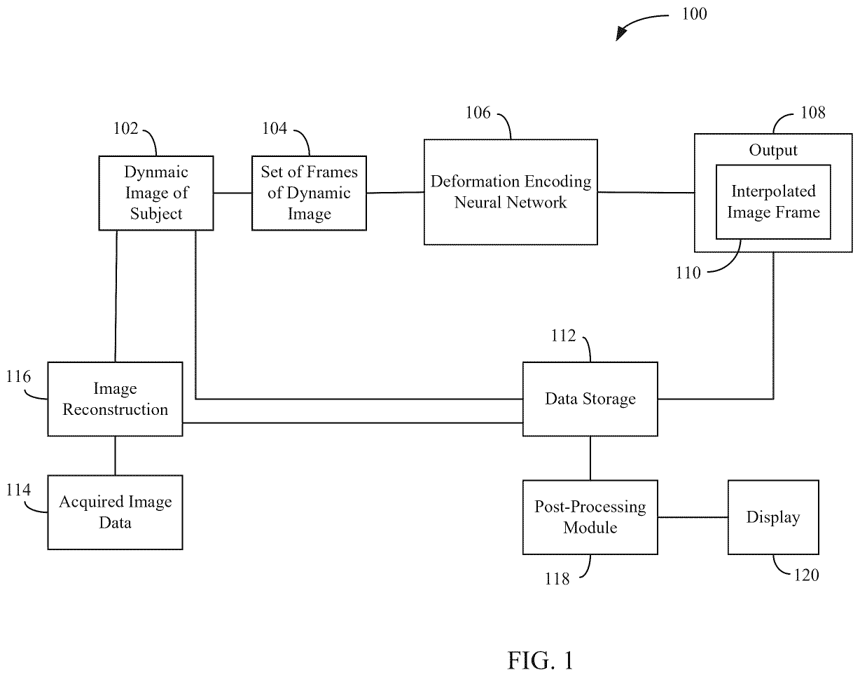

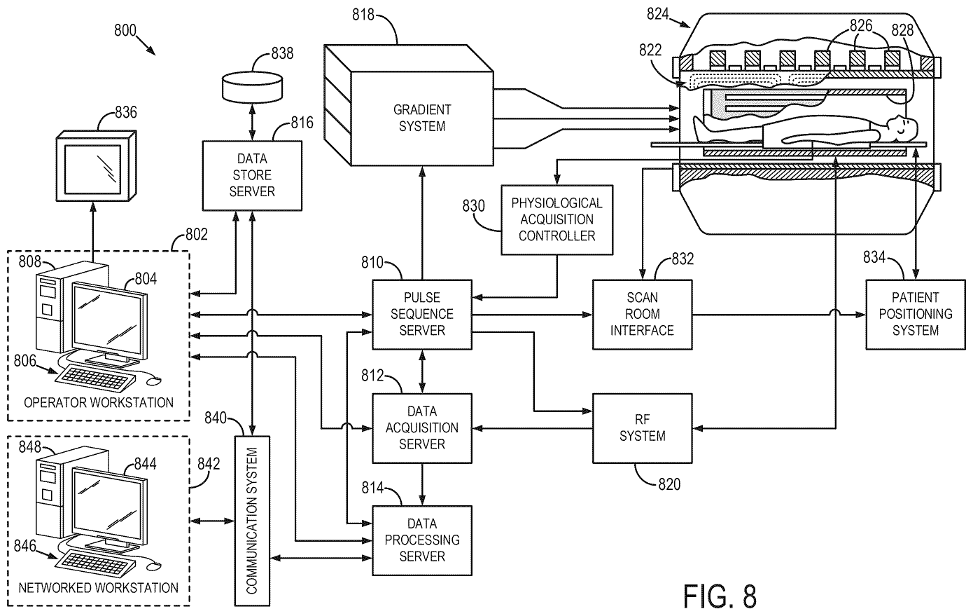

FIG. 1 is a block diagram of a system for increasing a frame rate of a dynamic image in accordance with an embodiment. The system 100 can include an input 104 including a set of frames from a dynamic image 102 of a subject, a deformation encoding neural network 106 (e.g., a deep learning neural network), an output 108 including a interpolated image frame 110, data storage 112, an image reconstruction module 116, a post-processing module 118, and a display 120. The system 100 may be configured to generate one or more interpolated image frames 110 for a dynamic image 102 of the subject using the deformation encoding neural network 106 and to generate a dynamic image with increased frame rate based on the original image frames of the dynamic image 102 of the subject and the one or more interpolated image frames. In some embodiments, the dynamic image 102 of the subject may be, for example, a dynamic MR image (e.g., a cardiac cine image, a phase contrast image, a perfusion image, etc.), or a dynamic image generated with other imaging modalities such as ultrasound, PET, echo cardiography. The dynamic image 102 of the subject may be acquired using an imaging system (e.g., an MRI system such as MRI system 800 shown in FIG. 8, an ultrasound system, a PET system, an echo cardiography system, etc.) using known acquisition techniques and protocols.

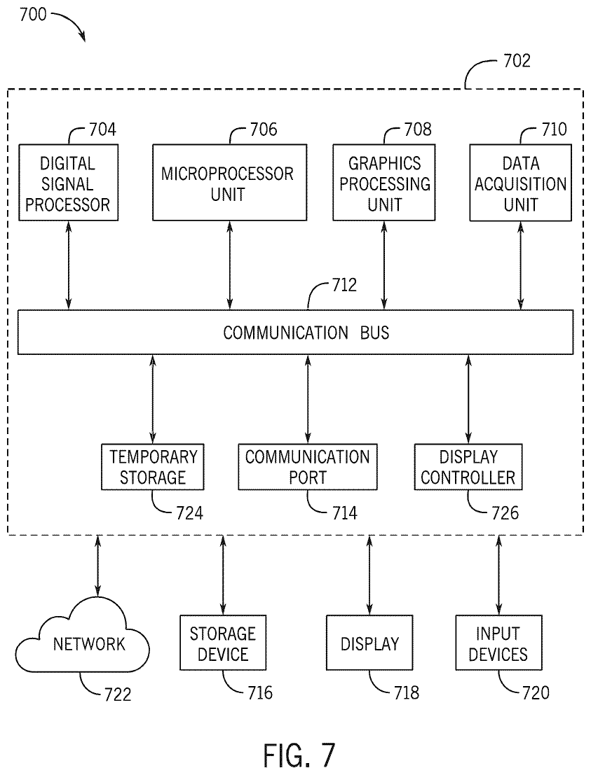

In some embodiments, the dynamic image 102 of the subject may be retrieved from data storage (or memory) 112 of system 100, data storage of an imaging system used to acquire the dynamic image 102, or data storage of other computer systems (e.g. storage device 716 of computer system 700 shown in FIG. 7). In some embodiments, the dynamic image 102 of the subject may be acquired in real time from a subject using an imaging system (e.g., MRI system 800 shown in FIG. 8) and the system 100 may be implemented inline with a reconstruction pipeline. For example, image data 114 can be acquired from a subject using an acquisition technique or protocol for the corresponding type of imaging system. The acquired image data 114 may be stored in, for example data storage of the imaging system, or data storage of other computer systems (e.g. storage device 716 if computer system 700 shown in FIG. 7). The acquired image data may then be reconstructed into a dynamic image 102 using image reconstruction module 116 and known reconstruction methods for the specific imaging modality. The dynamic image 102 generated by the image reconstruction module 116 may be stored in, for example, data storage of the imaging system, or data storage of other computer systems (e.g. storage device 716 if computer system 700 shown in FIG. 7).

The dynamic image 102 of the subject (or the first dynamic image) can include a plurality of image frames (or a first plurality of image frames) and have a frame rate (or a first frame rate). A set of consecutive image frames 104 may be selected from the plurality of image frames of the dynamic image 102 and may be provided as an input to the deformation encoding neural network 106. In some embodiments, the set of consecutive image frames 104 can include an even number of image frames, for example, 2, 4, 6, 8, etc. In some embodiments, the deformation encoding neural network 106 may be trained and configured to derive one or more parameters characterizing dynamics of the input set of consecutive image frames 104 and to generate an output 108 including generating an interpolated image frame 110 based on the one or more derived parameters. In some embodiments, the deformation encoding neural network 106 advantageously works in the image domain. The output 108 can also include the one or more parameters characterizing the dynamics of the set of consecutive image frames 104. In some embodiments, the interpolated image frame 110 is a new image frame between (e.g., temporally) the images frames in the input set of consecutive image frames 104. For example, in an embodiment where the dynamic image 102 of the subject has a temporal resolution of Δt (frame rate 1/Δt) and the input set of consecutive frames 104 includes four image frames acquired at times t−Δt, t, t+Δt, and t+2Δt, the output 108 of the deformation encoding neural network 106 can be an interpolated image frame at equivalent time t+0.5Δt.

The deformation encoding neural network 106 can be used to generate multiple interpolated image frames 110 for the dynamic image 102, one at a time, using a different set of consecutive image frames 104 of the dynamic image 102 as input to the deformation encoding neural network 106. In some embodiments, a sliding window technique may be used to select each set of consecutive image frames 104 of the dynamic image 102 used to generate the different interpolated image frames 110. For example, if the dynamic image 102 of the subject include 100 image frames, a first set of consecutive image frames 104 may include image frames 1-4. To select additional sets of consecutive image frames 104, the “sliding window” can be moved or shifted by one image frame and a second set of consecutive images frames 104 can include image frames 2-5, a third set of consecutive image frames 104 can include image frames 3-6, a fourth set of consecutive image frames 104 can include image frames 4-7, and so on until the end of the plurality image frames of the dynamic image 102 is reached. Accordingly, for an input set of consecutive image frames 104 that includes n image frames, every n image frames from the dynamic imagen 102 can selected as an input. For example, if the input set of consecutive image frames 104 includes four image frames, every four image frames of the dynamic image 102 may be selected as an input for the deformation encoding neural network 106.

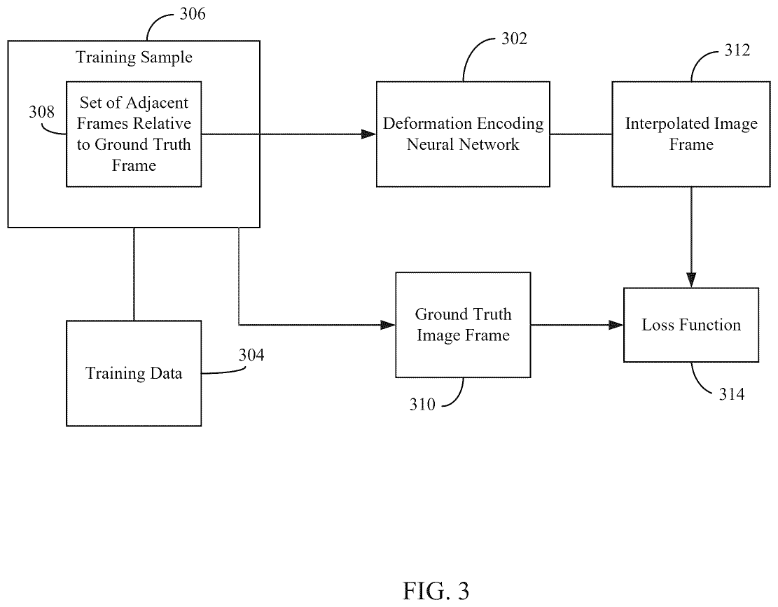

In some embodiments, the deformation encoding neural network 106 may be a deep learning neural network. In some embodiments, the deformation neural network may be implemented using deep learning models or architectures such as, for example, a transformer-based architecture, a convolutional neural network (CNN), etc. In some embodiments, the deformation encoding neural network 106 may be trained using a process that utilizes training samples created from a dynamic image training data set that can include dynamic images from multiple different centers (or sites), multiple different vendors (i.e., imaging system manufacturers), and the dynamic image training dataset can include dynamic images with different imaging acquisition characteristics (e.g., multiple different field strengths for MR dynamic images) and different frame rates (or temporal resolution). In some embodiments, training samples for each epoch can be created during training from the dynamic images in the training dataset. Each training sample can include, for example, a ground truth image frame and a set of adjacent image frames relative to the ground truth image frame selected from a training dynamic image and with a temporal spacing longer than the temporal spacing of the training dynamic image. Accordingly, each training sample can be synthesized to have a lower frame rate than the training dynamic image from which it is created. While various embodiments and examples are described herein with respect a set of adjacent image frames for a training sample including four adjacent image frames, it should be understood that other even numbers of frames may be used e.g., 2, 6, 8, etc.). An embodiment of a training process for the deformation encoding neural network 106 is described below with respect to FIGS. 3-5.

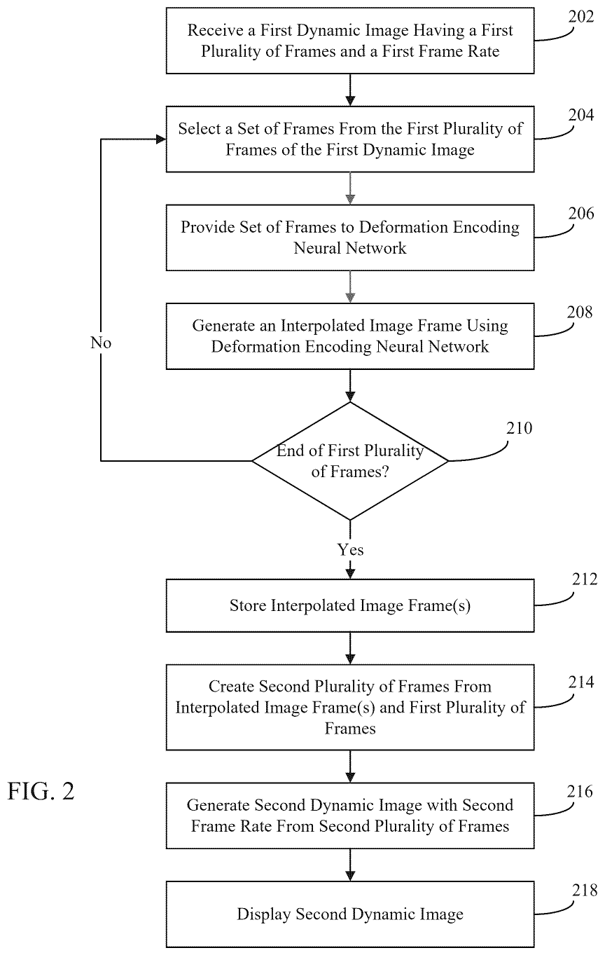

The output 108 of the deformation encoding neural network 106 including the generated interpolated image frame 110 and the derived one or more parameters may be stored in data storage 112. As discussed further below with respect to FIG. 2, the deformation encoding neural network 106 can be used to generate multiple interpolated image frames 110, one at a time, using a different set of consecutive image frames 104 of the dynamic image 102 as input to the deformation encoding neural network 106 for each interpolated image frame 110. In some embodiments, the one or more parameters derived by the deformation encoding neural network 106 can include, for example, motion, deformation, etc. For example, for cardiac cine imaging, the parameters can include motion and deformation of the heart and for phase contrast MR imaging, the parameters can include contrast changes.

The post-processing module 118 can receive the one or more interpolate image frames 110 generated by the deformation encoding neural network 106 (e.g., from data storage 112) and can create a second plurality of image frames including the interpolated images frames 110 for the dynamic image 102 and the original plurality of image frames (or the first plurality of images frames) of the dynamic image 102. In addition, the post-processing module 118 can be configured to generate a second dynamic image from the second plurality of image frames, where the second dynamic image has a second frame rate that is higher than the frame rate of the original dynamic image (or first dynamic image) 102 as a result of the additional interpolated image frames. The second plurality of image frames and the second dynamic image with the second increased frame rate can be stored in data storage 112 of system 100. The second dynamic image with an increased frame rate compared to the input dynamic image 102 can also be displayed on a display 118 (e.g., a display of an imaging system, display 718 of computer system 700 shown in FIG. 7). In some embodiments, the parameters derived by the deformation encoding neural network 106 may be used for further analysis and evaluation, for example, cardiac cine dynamic image, the deformation encoding neural network may derive and provide cardiac motion vector fields which can be utilized to assess cardiac deformation.

In some embodiments, the frame rate of the dynamic image 102 may be further increased by applying the deformation encoding neural network 106 to the second plurality of image frames of the second dynamic image resulting in a third plurality of image frames. For example, the second plurality of image frames (i.e., generated from the image frames of the dynamic image 102 and the interpolated image frames generated from a first application of the deformation encoding neural network 106 to the image frames of the dynamic image 102) can be used to create input sets of consecutive image frames 104 which may be input to the deformation encoding neural network 106 to generate additional interpolated image frames 110. Accordingly, a third of image frames can be created by combining the second plurality of image frames and the new interpolated frames generated from the second plurality of image frames. The third set of image frames can be used (e.g., by the post-processing module 118) to generate a third dynamic image with a third frame rate higher than the frame rate of the original dynamic image 102 (the first dynamic image) and the frame rate second dynamic image. For example, the second dynamic image may have a frame rate two times the first frame rate of the original dynamic image and the third dynamic image may have a frame rate four times the first frame rate of the original dynamic image. In some embodiments, the deformation encoding neural network 106 may be applied additional times until a desired increase in frame rate is achieved.

In some embodiments, the deformation encoding neural network 106, the image reconstruction module 116 and the post-processing module 118 may be implemented on one or more processors (or processor devices) of a computer system such as, for example, any general purpose computer system or device, such as a personal computer, workstation, cellular phone, smartphone, laptop, tablet, or the like. As such, the computer system may include any suitable hardware and components designed or capable of carrying out a variety of processing and control tasks, including, for example, steps for implementing the image reconstruction module 116, receiving a dynamic image 102 of a subject, selecting a set of consecutive image frames of the dynamic image, implementing the deformation encoding neural network 106, and implementing the post-processing module 118. For example, the computer system may include a programmable processor or combination of programmable processors, such as central processing units (CPUs), graphics processing units (GPUs), and the like. In some implementations, the one or more processors of the computer system may be configured to execute instructions stored in a non-transitory computer readable-media. In this regard, the computer system may be any device or system designed to integrate a variety of software, hardware, capabilities and functionalities. Alternatively, and by way of particular configurations and programming, the computer system may be a special-purpose system or device. For instance, such special-purpose system or device may include one or more dedicated processing units or modules that may be configured (e.g., hardwired, or pre-programmed) to carry out steps, in accordance with aspects of the present disclosure.

FIG. 2 illustrates a method for increasing a frame rate of a dynamic image in accordance with an embodiment. The process illustrated in FIG. 2 is described below as being carried out by the system 100 for increasing a frame rate of a dynamic image as illustrated in FIG. 1. Although the blocks of the process are illustrated in a particular order, in some embodiments, one or more blocks may be executed in a different order than illustrated in FIG. 2 or may be bypassed.

At block 202, a first dynamic image 102 of a subject may be received and the first dynamic image may have a first plurality of image frames and a first frame rate. As discussed above, the dynamic image 102 of the subject may be, for example, a dynamic MR image (e.g., a cardiac cine image, a phase contrast image, a perfusion image, etc.), or a dynamic image generated with other imaging modalities such as ultrasound, PET, echo cardiography. The dynamic image 102 of the subject may be acquired using an imaging system (e.g., an MRI system such as MRI system 800 shown in FIG. 8, an ultrasound system, a PET system, an echo cardiography system, etc.) using known acquisition techniques and protocols. The dynamic image 102 of the subject may be retrieved from data storage (or memory) 112 of system 100, data storage of an imaging system used to acquire the dynamic image 102, or data storage of other computer systems (e.g. storage device 716 of computer system 700 shown in FIG. 7). At block 204, a set of consecutive image frames 104 may be selected from the first plurality of image frames of the first dynamic image 102. A set of consecutive image frames 104 may be selected from the plurality of image frames of the dynamic image 102. In some embodiments, the set of consecutive image frames 104 can include an even number of image frames, for example, 2, 4, 6, 8, etc.

At block 206, the set of consecutive image frames 104 selected from the first dynamic image may be provided to a deformation encoding neural network 106. The deformation encoding neural network 106 may be a deep learning neural network. In some embodiments, the deformation neural network may be implemented using deep learning models or architectures such as, for example, a transformer-based architecture, a convolutional neural network (CNN), etc. At block 208, the deformation encoding neural network 106 may be used to generate an interpolated image frame 110. In some embodiments, the deformation encoding neural network 106 may be configured to derive one or more parameters characterizing dynamics of the input set of consecutive image frames 104 and to generate the interpolated image frame 110 based on the one or more derived parameters. The interpolated image frame 110 can be a new image frame between (e.g., temporally) the images frames in the input set of consecutive image frames 104. In some embodiments, the one or more parameters derived by the deformation encoding neural network 106 can include, for example, motion, deformation, etc. For example, for cardiac cine imaging, the parameters can include motion and deformation of the heart and for phase contrast MR imaging, the parameters can include contrast changes.

At block 210, it is determined whether the end of the first plurality of image frames of the dynamic image 102 has been reached. As mentioned above, the deformation encoding neural network 106 can be used to generate multiple interpolated image frames 110 for the first dynamic image 102, one at a time, using a different set of consecutive image frames 104 of the dynamic image 102 as input to the deformation encoding neural network 106 for each interpolated image frame 110. If the end of the first plurality of image frames of the first dynamic image 102 has not been reached at block 210, the process can return to block 204 and a different set of consecutive image frames 104 may be selected from the first plurality of image frames of the first dynamic image 102 to be input to the deformation encoding neural network 106 to generate another different interpolated image frame. In some embodiments, a sliding window technique may be used to select each set of consecutive image frames 104 of the dynamic image 102 used to generate the different interpolated image frames 110. For example, if the dynamic image 102 of the subject include 100 image frames and the set of consecutive image frames includes four image frames, a first set of consecutive image frames 104 may include image frames 1-4. To select additional sets of consecutive image frames 104, the “sliding window” can be moved or shifted by one image frame and a second set of consecutive images frames 104 can include image frames 2-5, a third set of consecutive image frames 104 can include image frames 3-6, a fourth set of consecutive image frames 104 can include image frames 4-7, and so on until the end of the plurality image frames of the dynamic image 102 is reached.

If the end of the first plurality of image frames of the first dynamic image 102 has been reached at block 210, the process moves to block 212 and the one or more interpolated image frames 110 generated by the deformation encoding neural network 106 based on the one or more sets of consecutive image frames of the first dynamic image 102 may be stored in a data storage 112. At block 214, a second plurality of image frames including the interpolated images frames 110 for the first dynamic image 102 and the original plurality of image frames (or the first plurality of images frames) of the first dynamic image 102 can be created, for example, using a post-processing module 118. At block 216, a second dynamic image may be generated from the second plurality of image frames (e.g., using the post-processing module 118), where the second dynamic image has a second frame rate that is higher than the first frame rate of the original dynamic image (or first dynamic image) 102 as a result of the additional interpolated image frames. At block 218, the second plurality of image frames and the second dynamic image with the second increased frame rate can be stored in data storage 112. The second dynamic image with an increased frame rate compared to the input dynamic image 102 can also be displayed on a display 120 (e.g., a display of an imaging system, display 718 of computer system 700 shown in FIG. 7). In some embodiments, the parameters derived by the deformation encoding neural network 106 at block 208 may be used for further analysis and evaluation, for example, cardiac cine dynamic image, the deformation encoding neural network may derive and provide cardiac motion vector fields which can be utilized to assess cardiac deformation.

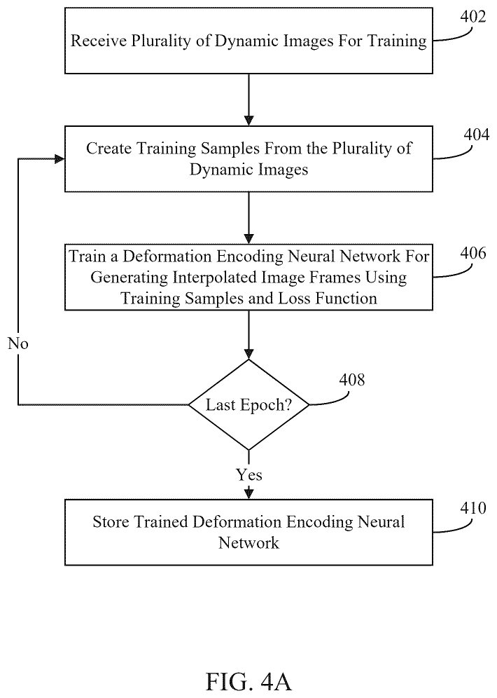

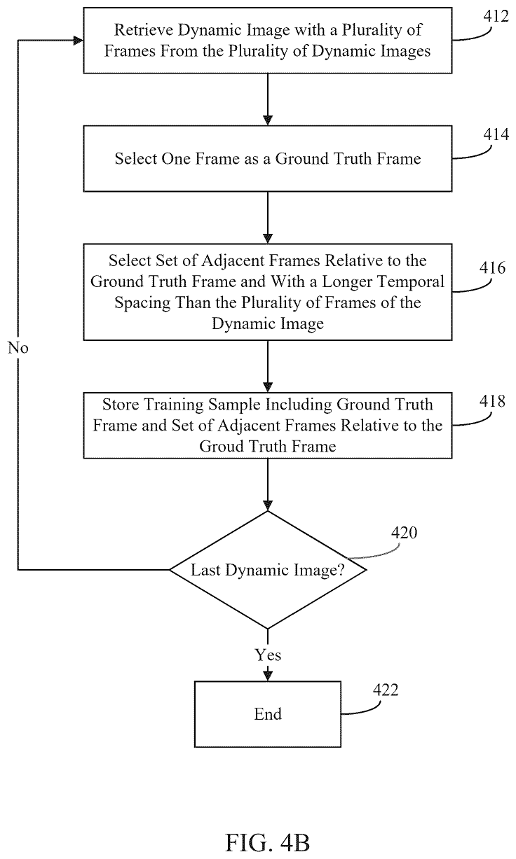

As mentioned above, a deformation encoding neural network 106 (shown in FIG. 1) may be trained to derive one or more parameters characterizing dynamics of the input set of consecutive image frames 104 and to generate an output 108 including generating an interpolated image frame 110 based on the one or more derived parameters. FIG. 3 is a block diagram illustrating a process for training a deformation encoding neural network for interpolating image frames for a dynamic image in accordance with an embodiment, FIG. 4A illustrates a method for training a deformation encoding neural network for interpolating image frames for a dynamic image in accordance with an embodiment, and FIG. 4B illustrates a method for generating training samples for a training dataset in accordance with an embodiment. The processes illustrated in FIGS. 4A and 4B are described below will reference to FIG. 3. Although the blocks of the process are illustrated in a particular order, in some embodiments, one or more blocks may be executed in a different order than illustrated in FIGS. 4A and 4B or may be bypassed.

At block 402, a plurality of training dynamic images (i.e., training data (or dataset) 304) may be received. In some embodiments, the plurality of training dynamic images can include existing dynamic images from multiple different centers (or sites, for example, a hospital, an imaging center, etc.), multiple different vendors (i.e., imaging system manufacturers), and the dynamic image training dataset can include dynamic images with different imaging acquisition characteristics (e.g., multiple different field strengths for MR dynamic images) and different frame rates (or temporal resolution). The plurality of training dynamic images (or training data 304) may be retrieved from data storage (or memory) 112 of system 100, data storage of an imaging system used to acquire the dynamic images, or data storage of other computer systems (e.g. storage device 716 of computer system 700 shown in FIG. 7).

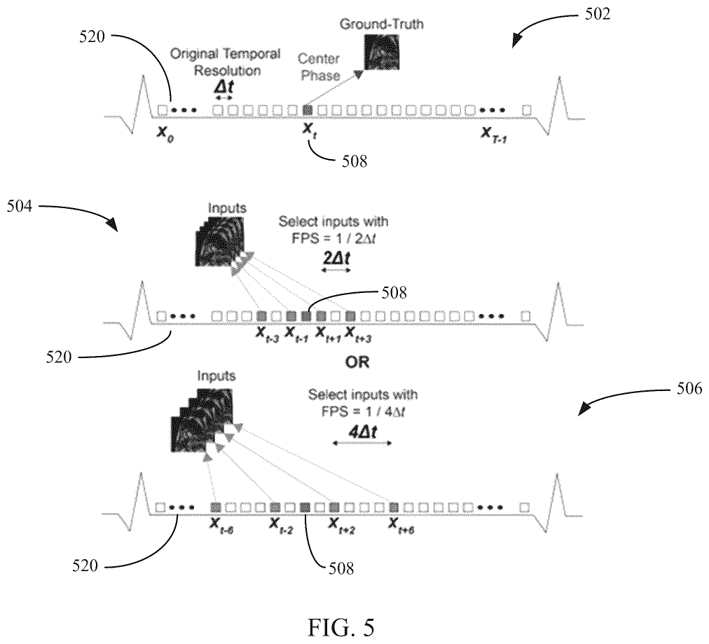

At block 404, training samples may be created from the plurality of training dynamic images (or training data 304). For each epoch of the training process, a training sample 306 may be created from each training dynamic image in the training data 304. As used herein, a epoch is one training or optimization loop across all training samples. In some embodiments, the training sample 306 can include a ground truth image frame 310 and a set of adjacent image frames 308 relative to the ground truth image frame, both selected from the image frames of a training dynamic image from the training dataset 304. In some embodiments, the ground truth image frame 310 can be selected randomly and the set of adjacent image frames may be selected to have a temporal spacing relative to the ground truth image frame that is longer than the temporal spacing of the image frames in the training dynamic image. Accordingly, each training sample can be synthesized to have a lower frame rate than the training dynamic image from which it is created. In some embodiments, the created training samples can include training samples with different framerates, namely the framerate reduction for different training samples can be implemented to varying degrees. For example, some training sample may have a frame rate reduced by two times and some training samples can have a frame rate reduced by four times. Creating training sample with multiple different frame rates can allow the deformation encoding neural network model to become resilient and robust to inputs (e.g., the input set of consecutive images 104 from a dynamic image 102, shown in FIG. 1) with a wide range of temporal resolutions. Accordingly, the trained deformation encoding neural network can work effectively with dynamic images 102 (shown in FIG. 1) with an initial frame rate that is either very low or intermediate, expanding the scope of applications where the deformation encoding neural network can be employed. In addition, the trained deformation encoding neural network can advantageously generate frame rates beyond what was initially available in the training data 304 for training. An example process for creating the training samples is discussed further below with respect to FIGS. 4B and 5.

At block 406, a deformation encoding neural network 302 may be trained for generating interpolated image frames 312 using the training samples 306 created from the training dynamic images (or training data 304) and a loss function 314. In some embodiments, for each training sample, the set of adjacent image frames 308 relative to the ground truth image frame 310 may be provided as an input to the deformation encoding neural network 302 which can generate an interpolated image frame 312 based on the input set of adjacent image frames 308. In some embodiments, the objective of the training is for the interpolated image frame 312 generated by the deformation encoding neural network 302 to match the ground truth image frame 310. Accordingly, the interpolated image frame 312 generated for each training sample 306 may be compared to the ground truth image frame 310 for the training sample 306 using a loss function 314. In some embodiments, the loss function is an L1 loss function. In some embodiments, the comparison of the interpolated image frame 312 to the ground truth image frame 310 can be used to calculate an error which can then be used to improve the deformation encoding neural network 302 model. In some embodiments, the loss function may be optimized using known optimization algorithms.

At block 408, it is determined if the last epoch for the current training has been reached. If the last epoch has not been reached, the process return to block 604 and a training sample 306 can be created from each training dynamic image in the training data 304. The deformation encoding neural network 302 may then be trained in this next training iteration using the created training samples. In some embodiments, a different training sample can be created from each training dynamic image for each epoch, because the ground truth image frame can be randomly selected. If the last epoch has been reached, at block 410 the trained deformation encoding neural network 302 can be stored in data storage (e.g., data storage of a computer system such as storage device 716 of computer system 700 shown in FIG. 7).

As mentioned above at block 404 of FIG. 4A, training samples may be created from the plurality of training dynamic images (or training data 304). In some embodiments, the training sample 306 can include a ground truth image frame 310 and a set of adjacent image frames 308 relative to the ground truth image frame, both selected from a training dynamic image from the training dataset 304. Referring to FIG. 4B, at block 412, a training dynamic image may be retrieved from the plurality of training dynamic images in the training data 304. The training dynamic image can include a plurality of image frames. At block 414, one frame of the plurality of image frames of the training dynamic image may be selected as a ground truth image frame 310. In some embodiments, the ground truth image frame 310 can be selected randomly. At block 416, a set of adjacent image frames 308 relative to the ground truth image frame 310 can be selected from the plurality of image frames of the training dynamic image. In some embodiments, the set of adjacent image fames 308 may be selected to have a temporal spacing relative to the ground truth image frame that is longer than the temporal spacing of the image frames in the training dynamic image. Accordingly, the training sample can be synthesized to have a lower frame rate than the training dynamic image from which it is created.

FIG. 5 is a block diagram illustrating a process for generating samples for a training dataset in accordance with an embodiment. In FIG. 5, a first diagram 502 illustrates the selection of a ground truth image frame 508 from a plurality of image frames 520 of a training dynamic image. The ground truth image frame 508 can also referenced to as xₜ, as shown in FIG. 5, where t is time. The ground truth image frame 508, xₜ, cam be randomly selected from the plurality of image frames 520 of the training dynamic image. In FIG. 5, the original temporal resolution of the training dynamic image is designated as Δt. As mentioned above, each training sample can be synthesized to have a lower frame rate than the training dynamic image from which it is created. In the example illustrated in FIG. 5, four image frames adjacent to xₜ may be selected as inputs using two equally probable patterns. A second diagram 504 illustrates the selection of an example set of adjacent image frames relative to the ground truth image frame 508 with a temporal resolution of 2Δt. The selected image frames can be xₜ₋₃, xₜ₋₁>xₜ₊₁, xₜ₊₃, which have a corresponding frame rate of ½Δt. A third diagram 506 illustrates the selection of an example set of adjacent image frames relative to the ground truth image frame 508 with a temporal resolution of 4Δt. The selected image frames can be xₜ₋₆, xₜ₋₂, xₜ₊₂, xₜ₊₆, which have a corresponding ¼Δt framerate. As mentioned, the set of adjacent image frames of a training sample may be provided as an input to the deformation encoding neural network 302 during training.

Returning to FIG. 4B, at block 418, the created training sample including the ground truth image frame and the set of adjacent frames relative to the ground truth frame may be stored in data storage 112. At block 420, it is determined if the last training dynamic image in the training set has been used to create a training sample for the current epoch. If the last training dynamic image has not been reached, the process can return to block 412 and the next training dynamic image can be retrieved from the training data 304 and used to create a training sample. If the last training dynamic image has been used to create a training sample, the process ends at block 422.

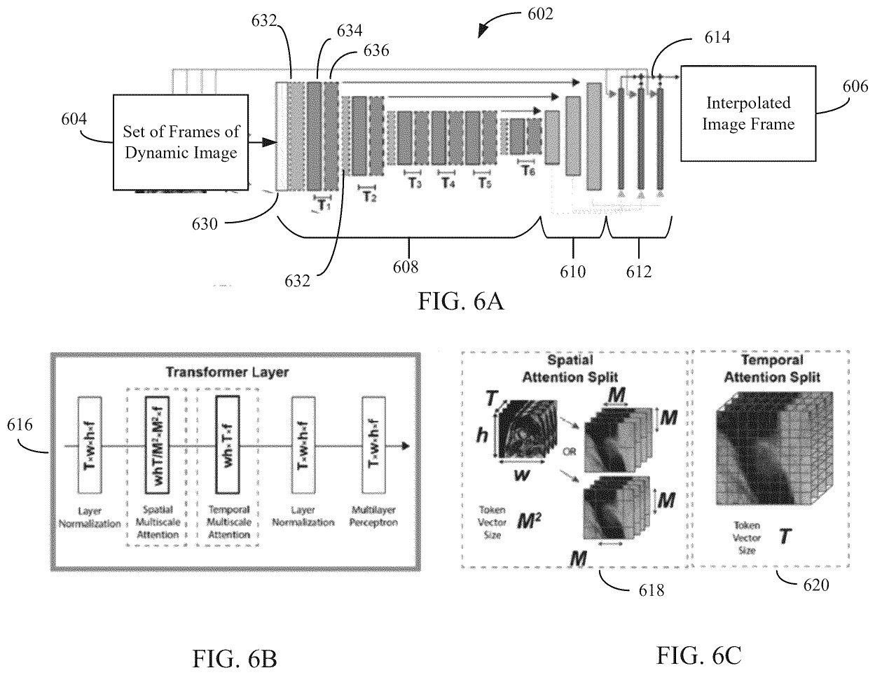

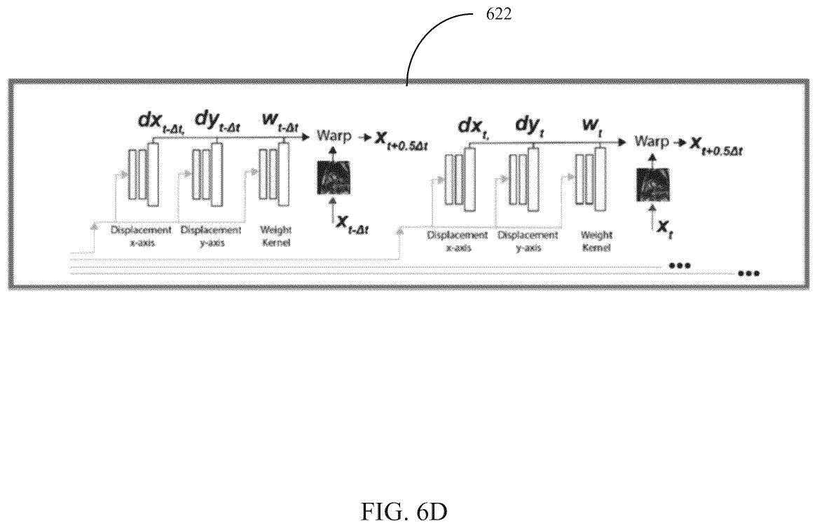

As discussed above, the deformation encoding neural network 106, 302 can be a deep learning neural network and can be implemented with a deep learning model or architecture such as, for example, a transformer-based architecture, a convolutional neural network (CNN), etc. FIGS. 6A-6D illustrate an example model architecture for a deformation encoding neural network for interpolating image frames for a dynamic image in accordance with an embodiment. In FIG. 6A, a transformer-based neural network architecture 602 for the deformation encoding neural network (e.g., deformation encoding neural networks 106, 302 shown in FIGS. 1 and 3) can include an input 604 for a set of consecutive image frames from a dynamic image of a subject, a transformer 608, three upsampling convolutional decoding layers 610, a multiscale deformation 612 and interpolation 614 layer, and an output 606 for a interpolated image frame. In some embodiments, each image frame in the set of consecutive image frames can have a size W×H. As mentioned above, in an example, the set of consecutive image frames can include four consecutive image frames collected with a temporal resolution Δt at t−Δt, t, t+Δt, and t+2Δt, and the output can be an interpolated image at t+0.5Δt. In the embodiment illustrated in FIG. 6A, the transformer 608 can include one embedding layer 630, four downsampling layers 632, and six pairs of transformer layers (e.g., pairs of a transformer layer 634 and a transformer layer with a shifted window 636) T1-T6. In some embodiments, the embedding layer 630 can be used to extract F features (e.g., F=32) per pixel from the input set of consecutive image frames 604 using a three-dimensional convolution of stride 1. In the example illustrated in FIG. 6A, the downsampling layers 632 precedes the transformer pairs T1, T2, T3 and T6 and can, for example, consist of a 3D convolution of stride 2 that each can reduce the dimensionality of each input image frame (e.g., W×H) by half while doubling the number of features F. In some embodiments, after each downsampling 632 (m=1-4), the size of the output was 2^{m}·F×T×W/2^{m}×H/2^{m}.

FIG. 6B shows an example transformer layer 616 that may be used in transformer 608 (e.g., in the transformer pairs T1-T6). In some embodiments, inputs to transformer layers can be split into windows along spatiotemporal dimensions, and self-attention can be applied to learn spatiotemporal dependencies within each window. In spatial attention 618 (FIG. 6C), the input can be split into N=W·H·T/M² non-overlapping windows of size M×M (M=8) to enable application of self-attention to spatial vectors of size M². Each window can have F features. Within a pair of layers, the window can be shifted for the second pair. The input can be split into N=W·H windows of size T×1 for temporal attention 620 (FIG. 6C).

The decoder 610 and the multiscale deformation 612 and interpolation 614 layer can use features from the transformer encoder 608 to capture parameters characterizing the dynamics of the input set of consecutive image frames (e.g., deformation) and scaling components. An example multiscale deformation and interpolation layer 622 is shown in FIG. 6D. First, each decoding layer 610 (l=1, 2, 3) can upsample the dimensionality W×H of the encoder 608 output by 2 while reducing the number of features F by half. These can then be concatenated with the outputs from previous encoding 608 layers and can be passed to the multiscale deformation 612 and interpolation 614 layer. In some embodiments, additional convolutional layers in the multiscale deformation 612 and interpolation 614 layer can then be used to upsample the input while predicting or generating parameters that characterize dynamics of the input set of consecutive image frames 604 and scaling components, for example, uₜ^{k,l}, Wₜ^{k,l}, Bₜ^{l}, where uₜ^{k,l} is the deformation, Wₜ^{k,l} is kernel weights and Bₜ^{l} is a blending mask. The parameters and scaling components can be used to sample and combine the input image frames 604 onto a single frame using a blending mask to generate an interpolated image frame 606. In one example, for an input set of four consecutive image frames, the predicted parameters (e.g., deformation) and scaling W components can be used to sample and combine the four image frames onto a single frame at t+0.5Δt using a blending mask In another example, for an embodiment where the dynamic image is a cine MR image, deformation may be given by u=dx\hat{l}+dyĵ. In this example, at each layer l, the deformation can be characterized, for example, by uₜ^{k}, composed of k displacement vectors per pixel p₀. In this example, the new interpolated image frame for the dynamic cine MR image (e.g., a new cardiac phase) may be synthesized by sampling the vector locations and linearly combining the output using Wₜ^{k} for scaling. A blending mask Bₜ, may then be used to combine estimates, for example, a blending mask given by:

$${x}_{t + 0.5 Δ t} ( {p}_{0} ) = {\sum }_{τ = \{ t - Δ t , t , t + Δ t , t + 2 Δ t \}} {B}_{τ} ( {p}_{0} ) ( {\sum }_{k = 1}^{K} {W}_{τ}^{k} ( {p}_{0} ) \cdot {x}_{τ} ( {p}_{0} + {u}_{τ}^{k} ( {p}_{0} ) ) ) . \qquad ( 1 )$$

In some embodiments, the output 610 of the model 602 can also include the derived parameters, scaling components and blending mask.

FIG. 7 is a block diagram of an example computer system in accordance with an embodiment. Computer system 700 may be used to implement the systems and methods described herein. In some embodiments, the computer system 700 may be a workstation, a notebook computer, a tablet device, a mobile device, a multimedia device, a network server, a mainframe, one or more controllers, one or more microcontrollers, or any other general-purpose or application-specific computing device. The computer system 700 may operate autonomously or semi-autonomously, or may read executable software instructions from the memory or storage device 716 or a computer-readable medium (e.g., a hard drive, a CD-ROM, flash memory), or may receive instructions via the input device 720 from a user, or any other source logically connected to a computer or device, such as another networked computer or server. Thus, in some embodiments, the computer system 700 can also include any suitable device for reading computer-readable storage media.

Data, such as data acquired with an imaging system (e.g., a magnetic resonance imaging (MRI) system) may be provided to the computer system 700 from a data storage device 716, and these data are received in a processing unit 702. In some embodiment, the processing unit 702 includes one or more processors. For example, the processing unit 702 may include one or more of a digital signal processor (DSP) 704, a microprocessor unit (MPU) 706, and a graphics processing unit (GPU) 708. The processing unit 702 also includes a data acquisition unit 710 that is configured to electronically receive data to be processed. The DSP 704, MPU 706, GPU 708, and data acquisition unit 710 are all coupled to a communication bus 712. The communication bus 712 may be, for example, a group of wires, or a hardware used for switching data between the peripherals or between any components in the processing unit 702.

The processing unit 702 may also include a communication port 714 in electronic communication with other devices, which may include a storage device 716, a display 718, and one or more input devices 720. Examples of an input device 720 include, but are not limited to, a keyboard, a mouse, and a touch screen through which a user can provide an input. The storage device 716 may be configured to store data, which may include data such as, for example, dynamic images, training data, interpolated image frames, whether these data are provided to, or processed by, the processing unit 702. The display 718 may be used to display images and other information, such as magnetic resonance images, patient health data, and so on.

The processing unit 702 can also be in electronic communication with a network 722 to transmit and receive data and other information. The communication port 714 can also be coupled to the processing unit 702 through a switched central resource, for example the communication bus 712. The processing unit can also include temporary storage 724 and a display controller 726. The temporary storage 724 is configured to store temporary information. For example, the temporary storage 724 can be a random access memory.

In some embodiments, the disclosed systems and methods may be implemented using or designed to accompany an imaging system such as, for example, a magnetic resonance imaging (“MRI”) system 100, such as is illustrated in FIG. 8. The MRI system 800 includes an operator workstation 802, which will typically include a display 804, one or more input devices 806 (such as a keyboard and mouse or the like), and a processor 808. The processor 808 may include a commercially available programmable machine running a commercially available operating system. The operator workstation 802 provides the operator interface that enables scan prescriptions to be entered into the MRI system 800. In general, the operator workstation 802 may be coupled to multiple servers, including a pulse sequence server 810; a data acquisition server 812; a data processing server 814; and a data store server 816. The operator workstation 802 and each server 810, 812, 814, and 816 are connected to communicate with each other. For example, the servers 810, 812, 814, and 816 may be connected via a communication system 840, which may include any suitable network connection, whether wired, wireless, or a combination of both. As an example, the communication system 840 may include proprietary networks, dedicated networks, as well as open networks, such as the internet.

The pulse sequence server 810 functions in response to instructions downloaded from the operator workstation 802 to operate a gradient system 818 and a radiofrequency (“RF”) system 820. Gradient waveforms to perform the prescribed scan are produced and applied to the gradient system 818, which excites gradient coils in an assembly 822 to produce the magnetic field gradients Gₓ, G_{y}, G_{z} used for position encoding magnetic resonance signals. The gradient coil assembly 822 forms part of a magnet assembly 824 that includes a polarizing magnet 826 and a whole-body RF coil 828.

RF waveforms are applied by the RF system 820 to the RF coil 828, or a separate local coil (not shown in FIG. 8), in order to perform the prescribed magnetic resonance pulse sequence. Responsive magnetic resonance signals detected by the RF coil 828, or a separate local coil, are received by the RF system 820, where they are amplified, demodulated, filtered, and digitized under direction of commands produced by the pulse sequence server 810. The RF system 820 includes an RF transmitter for producing a wide variety of RF pulses used in MRI pulse sequences. The RF transmitter is responsive to the scan prescription and direction from the pulse sequence server 810 to produce RF pulses of the desired frequency, phase, and pulse amplitude waveform. The generated RF pulses may be applied to the whole-body RF coil 828 or to one or more local coils or coil arrays.

The RF system 820 also includes one or more RF receiver channels. Each RF receiver channel includes an RF preamplifier that amplifies the magnetic resonance signal received by the coil 828 to which it is connected, and a detector that detects and digitizes the/and Q quadrature components of the received magnetic resonance signal. The magnitude of the received magnetic resonance signal may, therefore, be determined at any sampled point by the square root of the sum of the squares of the/and Q components:

$$M = \sqrt{{I}^{2} + {Q}^{2}} \qquad ( 2 )$$

and the phase of the received magnetic resonance signal may also be determined according to the following relationship:

$$φ = {tan}^{- 1} ( \frac{Q}{I} ) \qquad ( 3 )$$

The pulse sequence server 810 also optionally receives patient data from a physiological acquisition controller 830. By way of example, the physiological acquisition controller 830 may receive signals from a number of different sensors connected to the patient, such as electrocardiograph (“ECG”) signals from electrodes, or respiratory signals from a respiratory bellows or other respiratory monitoring device. Such signals are typically used by the pulse sequence server 810 to synchronize, or “gate,” the performance of the scan with the subject's heart beat or respiration.

The pulse sequence server 810 also connects to a scan room interface circuit 832 that receives signals from various sensors associated with the condition of the patient and the magnet system. It is also through the scan room interface circuit 832 that a patient positioning system 834 receives commands to move the patient to desired positions during the scan.

The digitized magnetic resonance signal samples produced by the RF system 820 are received by the data acquisition server 812. The data acquisition server 812 operates in response to instructions downloaded from the operator workstation 802 to receive the real-time magnetic resonance data and provide buffer storage, such that no data is lost by data overrun. In some scans, the data acquisition server 812 does little more than pass the acquired magnetic resonance data to the data processor server 814. However, in scans that require information derived from acquired magnetic resonance data to control the further performance of the scan, the data acquisition server 812 is programmed to produce such information and convey it to the pulse sequence server 810. For example, during prescans, magnetic resonance data is acquired and used to calibrate the pulse sequence performed by the pulse sequence server 810. As another example, navigator signals may be acquired and used to adjust the operating parameters of the RF system 820 or the gradient system 818, or to control the view order in which k-space is sampled. In still another example, the data acquisition server 812 may also be employed to process magnetic resonance signals used to detect the arrival of a contrast agent in a magnetic resonance angiography (“MRA”) scan. By way of example, the data acquisition server 812 acquires magnetic resonance data and processes it in real-time to produce information that is used to control the scan.

The data processing server 814 receives magnetic resonance data from the data acquisition server 812 and processes it in accordance with instructions downloaded from the operator workstation 802. Such processing may, for example, include one or more of the following: reconstructing two-dimensional or three-dimensional images by performing a Fourier transformation of raw k-space data; performing other image reconstruction techniques, such as iterative or back-projection reconstruction techniques; applying filters to raw k-space data or to reconstructed images; generating functional magnetic resonance images; calculating motion or flow images; and so on.

Images reconstructed by the data processing server 814 are conveyed back to the operator workstation 802. Images may be output to operator display 812 or a display 836 that is located near the magnet assembly 824 for use by attending clinician. Batch mode images or selected real time images are stored in a host database on disc storage 838. When such images have been reconstructed and transferred to storage, the data processing server 814 notifies the data store server 816 on the operator workstation 802. The operator workstation 802 may be used by an operator to archive the images, produce films, or send the images via a network to other facilities.

The MRI system 800 may also include one or more networked workstations 842. By way of example, a networked workstation 842 may include a display 844, one or more input devices 846 (such as a keyboard and mouse or the like), and a processor 848. The networked workstation 842 may be located within the same facility as the operator workstation 802, or in a different facility, such as a different healthcare institution or clinic. The networked workstation 842 may include a mobile device, including phones or tablets.

The networked workstation 842, whether within the same facility or in a different facility as the operator workstation 802, may gain remote access to the data processing server 814 or data store server 816 via the communication system 840. Accordingly, multiple networked workstations 842 may have access to the data processing server 814 and the data store server 816. In this manner, magnetic resonance data, reconstructed images, or other data may exchange between the data processing server 814 or the data store server 816 and the networked workstations 842, such that the data or images may be remotely processed by a networked workstation 842. This data may be exchanged in any suitable format, such as in accordance with the transmission control protocol (“TCP”), the internet protocol (“IP”), or other known or suitable protocols.

Computer-executable instructions for increasing a frame rate of a dynamic image and training a deformation encoding neural network for interpolating an image frame according to the above-described methods may be stored on a form of computer readable media. Computer readable media includes volatile and nonvolatile, removable, and non-removable media implemented in any method or technology for storage of information such as computer readable instructions, data structures, program modules or other data. Computer readable media includes, but is not limited to, random access memory (RAM), read-only memory (ROM), electrically erasable programmable ROM (EEPROM), flash memory or other memory technology, compact disk ROM (CD-ROM), digital volatile disks (DVD) or other optical storage, magnetic cassettes, magnetic tape, magnetic disk storage or other magnetic storage devices, or any other medium which can be used to store the desired instructions and which may be accessed by a system (e.g., a computer), including by internet or other computer network form of access

The present invention has been described in terms of one or more preferred embodiments, and it should be appreciated that many equivalents, alternatives, variations, and modifications, aside from those expressly stated, are possible and within the scope of the invention.

1. A system for increasing a frame rate of a dynamic image, the system comprising:
an input for receiving a set of consecutive image frames of a first dynamic image, wherein the first dynamic image has a first plurality of image frames and a first frame rate;
a deformation encoding neural network coupled to the input and configured to derive at least one parameter characterizing dynamics of the set of consecutive image frames and to generate an interpolated image frame based on the at least one parameter; and
a post-processing module coupled to the deformation encoding neural network and configured to receive one or more interpolated image frames from the deformation encoding neural network, to create a second plurality of image frames comprising the one or more interpolated image frames and the first plurality of image frames, and to generate a second dynamic image using the second plurality of image frames, the second dynamic image having a second frame rate higher than the first frame rate.

2. The system according to claim 1, wherein the set of consecutive image frames comprises four consecutive image frames.

3. The system according to claim 1, wherein the first dynamic image and the second dynamic image are magnetic resonance dynamic images.

4. The system according to claim 1, wherein the deformation encoding neural network comprises a transformer-based deep learning architecture.

5. A method for increasing a frame rate of a dynamic image, the method comprising:
receiving a first dynamic image having a first plurality of image frames and a first frame rate;
selecting a plurality of sets of consecutive image frames from the first plurality of image fames of the first dynamic image;
for each set of consecutive image frames:
providing the set of consecutive image frames to a deformation encoding neural network;
generating an interpolated image frame using the deformation encoding neural network by deriving at least one parameter characterizing dynamics of the set of consecutive image frames and generating the interpolated image frame based on the at least one parameter; and
storing the interpolated image frame in data storage;
creating a second plurality of image frames comprising the first plurality of image frames and the interpolated image frame generated from each set of consecutive image frames; and
generating a second dynamic image using the second plurality of image frames, the second dynamic image having a second frame rate higher than the first frame rate.

6. The method according to claim 5, wherein selecting a plurality of sets of consecutive image frames from the first plurality of image fames of the first dynamic image comprises using a sliding window technique.

7. The method according to claim 5, wherein each set of consecutive image frames comprises four consecutive image frames.

8. The method according to claim 5, wherein the first dynamic image and the second dynamic image are magnetic resonance dynamic images.

9. The method according to claim 5, wherein the deformation encoding neural network comprises a transformer-based deep learning architecture.

10. A method for training a deformation encoding neural network for interpolating an image frame, the method comprising:
receiving a plurality of dynamic images, wherein each dynamic image has a plurality of image frames;
generating a training sample from each dynamic image, comprising:
selecting an image frame from the plurality of image frames of the dynamic image for a ground truth image frame;
selecting a set of adjacent image frames relative to the ground truth image frame and with a longer temporal spacing than a temporal spacing of the plurality of image frames in the dynamic image; and
storing the training sample including the ground truth image frame and the set of adjacent image frames relative to the ground truth image frame;
training the deformation encoding neural network for interpolating an image frame using each generated training sample and a loss function; and
storing the trained deformation encoding neural network for interpolating an image frame in data storage.

11. The method according to claim 10, wherein the loss function is an L1 loss function.

12. The method according to claim 10, wherein the set of adjacent image frames relative to the ground truth image frame comprises four image frames.

13. The method according to claim 10, wherein training the deformation encoding neural network for interpolating an image frame using each generated training sample and a loss function comprises, for each training sample:
providing the set of adjacent image frames of the training sample to the deformation encoding neural network;
generating an interpolated image frame using the deformation encoding neural network; and
comparing the interpolated image frame to the ground truth image frame of the training sample using the loss function.

14. The method according to claim 13, wherein training the deformation encoding neural network for interpolating an image frame using each generated training sample and a loss function further comprises optimizing the loss function.

15. The method according to claim 13, wherein the interpolated image frame is between the images frames in the set of adjacent image frames.

16. The method according to claim 13, wherein generating an interpolated image frame using the deformation encoding neural network comprises deriving at least one parameter characterizing dynamics of the set of adjacent image frames, wherein the interpolated image frame is generated based on the at least one parameter.

17. The method according to claim 10, wherein the plurality of dynamic images are magnetic resonance dynamic images.
